(19) United States
(12) Patent Application Publication
(10) Pub. No.: US 2014/0136506 A1
(43) Pub. Date: May 15, 2014

(54) SYSTEM AND METHOD FOR SELECTING DATA TO BE PRESENTED ON A WEB SITE

(71) Applicant: SOFTLIB LTD., Tel Aviv (IL)

(72) Inventors: Aki Ratner, Ramat Gan (IL); Boaz Grinvald, Tel Mond (IL); David Buch, Hod Hasharon (IL); Maxim Donde, Netanya (IL)

(73) Assignee: SOFTLIB LTD., Tel Aviv (IL)

(21) Appl. No.: 13/676,200

(22) Filed: Nov. 14, 2012

(51) Int. Cl. G06F 17/30

(52) U.S. Cl. 707/706; 707/748; 707/E17.033; 707/E17.108

(57) ABSTRACT

A system and method for selecting content to be presented to a user of a web site by identifying a topic of a content item on a web site using a ranking of a significance of terms relating to the topic in the content item, identifying a topic of interest on the web site of the user from an input of the user into the web site, and selecting the content item with the highest significance ranking for the topic of interest of the user.

### FIELD OF THE INVENTION

This application relates to automatically selecting content items on a web site to be presented to a user, and particularly to associating topics of content items on the web site with topics of interest of a user of the web site, and presenting such content items to the user.

### BACKGROUND OF THE INVENTION

Owners or operators of web sites may expend resources on encouraging users to visit their web sites. Frequently, however, once the user visits the web site, the user must rely on his own navigation of the web site to find information on the good or service that the user seeks. Many web sites present visitors with a fixed structure of information and content stored on the web site, requiring the user to work through such structure to find information, services or products that match the user's particular interests and goals. Users may become frustrated with such navigation, and may navigate away from the site before finding relevant information or being presented with the offers or data that satisfy their goals.

### SUMMARY OF EMBODIMENTS OF THE INVENTION

Embodiments of the invention may include identifying for one or more content items on a web site or group of related web sites, a topic of a content item from a group of topics, where such identifying uses a ranking of a significance to the topic of a term in the content item. An embodiment of a method may further include identifying a topic of interest of a user of the web site from a group of topics of interest, where such identifying uses a ranking of a significance to the topic of interest of an input to the web site of the user. An embodiment of a method may further include associating the identified topic with the identified topic of interest, and identifying a first of the content items as having a highest significance ranking to the identified topic. An embodiment of a method may include presenting to the user the identified content item as it is inserted into a web page of the web site presented to the user.

In some embodiments, identifying the topic of interest of the user includes ranking a significance of the user's request for a web page on web site.

In some embodiments, identifying the topic of interest of the user includes ranking a significance to the topic of interest of a web page first presented to the user upon the user's entry to the web site.

In some embodiments, identifying a topic of a content item by a ranking of a significance to the topic of a term in the content item may include ranking the significance based on a format (such as a bold or italics format) of the term in the content item, a position of the term in a title of the content item, an appearance of the term in a title of the content item, a number of words included in the term, an appearance of a number in the term, and an appearance of a proper noun in the term.

In some embodiments, identifying a topic of a content item by a ranking of a significance may include determining a frequency of a use of the term in the content item.

In some embodiments, identifying a topic of a content item by a ranking of a significance may include determining a frequency of the use of the term in a content item relative to a use of the term in other content items.

In some embodiments, presenting the content item to a user may include presenting a portion of the content item that includes less than all of the content item but that includes the term.

In some embodiments, a method may include identifying a second content item on a second web site by a ranking of a significance of such second content item to the topic; and presenting to the user the content item on the second web site as it is inserted into a web page of the first web site.

In some embodiments, a method may include recording an association of the topic of interest with the user, and recalling the association of the topic of interest with the user upon a visit of the user to the web site.

In some embodiments an input of a user to a web site may include an input of a user to a search engine of another web site, where such input was included in a search that led the user to the web site having the content item.

Embodiments of the invention may include a system that selects content items to present to a user of a web site, where the system may include a memory to store topics and content items of the web site, and a processor, where the processor may identify a topic of one or more content items on the web site by a ranking of a significance to the topic of a term in the content item. The processor may identify a topic of interest of a user of the web site by a ranking of a significance to the topic of interest of the user of an input form the user to the web site. The processor may associate the topic with the topic of interest, and identify a content item as having a highest significance ranking to the identified topic. The processor may present the identified content item having the highest ranking, and may insert the content item into a web page of the web site.

In some embodiments, the processor may identify the topic of interest of the user by ranking of a significance to the topic of interest of the user of a word that is inputted into the web site by the user.

In some embodiments, the processor may identify the user's topic of interest by ranking a significance to the topic of interest of a request for a web page inputted to the web site by the user.

In some embodiments, the processor may identify the topic of interest of the user by using a ranking of a significance to the topic of interest of a web page that is first presented to the user as the user enters the web site. For example, such first presented page may include the ‘landing page, where the user first surfed to or entered the web site.

Embodiments of the invention may include a method for presenting to a user data on a web site, where such method may include collecting a term from content on the web site, associating one or more of such terms with a topic, associating the topic with one or more content items on the web site, determining that a content item that is viewed by or presented to a user is associated with the topic; and presenting to the user another content item that is also associated with the topic.

In some embodiments, a term or other data that is inputted to the web site by a user may be associated with a topic of one or more content items. In some embodiments, a user may be prompted with words or questions that may relate to one or more topics, and the user may select or otherwise respond to such prompts

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows a schematic diagram of devices connected to a network on which is stored data associated with a web site, in accordance with an embodiment of the invention;

FIG. 2 is a categorization by topics of lists of words and terms collected from content on a web site or related to such content, and an association of such topics with content items stored on the web site, in accordance with an embodiment of the invention;

FIG. 3 is a depiction of a help and tracking function on a screen of a web page, in accordance with an embodiment of the invention;

FIG. 4 is a flow diagram of a method in accordance with an embodiment of the invention; and

FIG. 5 is a flow diagram of a method in accordance with an embodiment of the invention.

### DETAILED DESCRIPTION OF THE PREFERRED EMBODIMENTS

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the embodiments of the invention.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution by for example a processor or group of processors result in a method of an embodiment of the invention. Embodiments of the invention may include an article such as a computer or processor non-transitory storage readable medium, or a non-transitory computer or processor storage medium, such as for example a memory, a disk drive, or a USB or other flash memory, encoding, including or storing computer readable instructions which when executed by a processor or controller, carry out methods disclosed herein. In some embodiments of the invention, methods discussed herein may be carried out by one or more processors executing code stored in memory or another storage medium. While specific structures and hardware are discussed herein, embodiments of the invention may be carried out by systems having other structures.

As used in this application, and in addition to its regular meaning, the term ‘web site’ may include one or more web-based or virtual pages having content thereon that may be or include text, data, images and video organized under one or a series of related web domain names or URL's. In some embodiments, a relationship among web domains or URL's may be designated or defined by an owner or manager of a web site. Such web pages may be accessed by and presented to a remote user or visitor of the web site by way of for example a web server that may transmit data making up the web site to a user's computer for presentation on a screen or viewer (e.g., the user computer may execute a browser to display the web site). Content included or presented in pages of the web site may include words, terms, phrases, images, sounds, video or other depictions of information related to one or more topics.

As used in this application and in addition to its regular meaning the term ‘topic’ may refer to a field of interest, a category having related content, ideas, products or services, or other groupings of data. Content of a web site may be divided or categorized into one or more topics connected to or relating to one or more goods, services, themes or fields of information offered by, presented on or discussed on the web site. For example, a web site that offers products and information about cleaning materials may include topics relating to different cleaning materials and items to be cleaned. Words, terms or phrases about cleaning may include for example, soap, detergent and stain and each of such words, terms or phrases may be deemed a topic. A sub-topic associated or designated for the site may relate to for example cleaning animals. Words, terms or phrases found in content on the web site about cleaning animals may include some or all of the terms or phrases about cleaning and may also include terms such as fur, shampoo, shed, paws, and bark, though the later group of terms may be relevant to the sub-topic of cleaning products for dogs. Other terms and phrases may be known to be related to content on a web site even though such terms or phrases may not be present, included or actually appear in the content of the web site. For example the terms mange, demodectic, and cheyletiella may be associated with or related to skin conditions of dogs, but may not actually appear as terms in content of a web site. Such terms may nevertheless he categorized as relating to the topic of cleaning dogs and to a sub-sub-topic of cleaning dogs that have skin conditions.

As used in this application, the term ‘content item’ may, in addition to its regular meaning, also mean text, images, banners, advertisements, music, video, illustrations or other forms of data that may be presented or available to a user on a web site. In some embodiments, a content item may include a portion of a web page such as a banner, advertisement, image, customized message, or inserted portion of a web page or text.

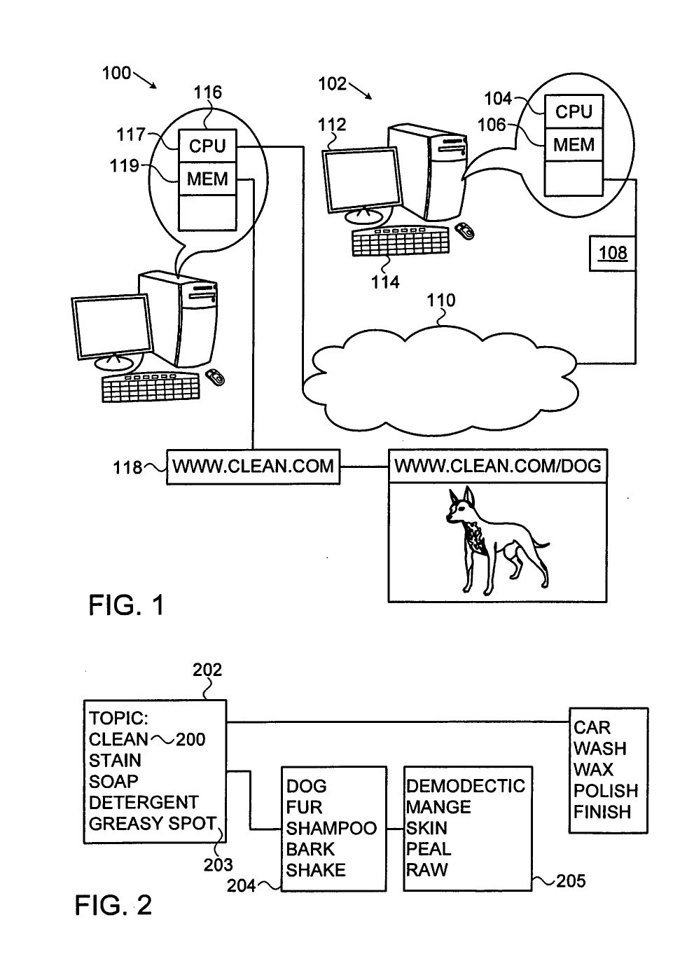

Reference is made to FIG. 1, a schematic diagram of devices connected to a network on which is stored data associated with a web site. A system 100 may include electronic devices such as a computer 102, having one or more processors 104, a memory 106 such as a hard drive, RAM or other mass data storage device, a communication device 108 such as a modem, a server 116 to support data communication over a network 110 such as for example the Internet, a processor 117 and a memory 119 associated with server 116, an output device such as a display or screen 112, and an input device 114 such as a keyboard or mouse. Data in the form of text, images, sounds, numbers, etc. may be stored in web server 116, and may be organized for access under one or more web sites 118, domain names or uniform resource locators (URLs). Web site 118 may include one or more web pages 120 or collections of data or content presented as screen views that are accessible from web site 118. Web pages may include one or more areas or spaces to be presented to a user or visitor to such page, where the content item in such page may be varied or changed to reflect an interest of a user. In some embodiments, data may be stored in a remote server and accessed over a wireless network such as for example a cellular network, the Internet, a wide area network or others wireless or wired networks. In some embodiments, a user may access a web site from a mobile device such as a cellular phone, tablet computer or other mobile device, over for example a wireless network. A user or visitor may view a web page 120 by executing a browser or other program on a user computer, which uses the web site data provided by server 116 to produce a web site display.

In some embodiments, a method or system of the invention may include a series of for example software instructions that may be added or overlaid onto an existing web site 118, group of web pages 120 or server 116, such that one or more functions may be implemented by for example a manager or owner of a web site without significantly altering a structure or operation of web site 118. In some embodiments, one or more functions of robot 210 as is described further below, may be executed or performed by one or more software instructions that may be executed by one or more processors.

Reference is made to FIG. 2, a categorization by topics of a list of words and terms collected from content stored in a web site or related to such content, and an association of such topics with content items stored, in accordance with an embodiment of the invention. In some embodiments, a review or parse may be performed on content available from or stored on one or more web pages 120 of web site 118. Such parse may include an evaluation or selection of words 200, terms 203, phrases, images or sounds, and a grouping or categorizing of such data into topics 202, sub-topics 204 and sub-sub-topics 205. Redundant or insignificant terms may be excluded from topics 202, or differentiated from significant terms 203. A topic 202 may be a sub-topic 204 of another topic 202, and a sub topic 204 may be a sub-sub topic 205 of more than one topic 202. Other combinations are possible.

For example, a first web page may include an offer for dog shampoo, and a second web page may include instructions for caring for shaggy dogs that have demodectic skin. The terms ‘dog’, ‘shampoo’ and ‘fur’ may be associated with a web page that offers dog shampoo, and the term demodectic (which may or may not appear in the web site) may be associated with an article or white paper that is available on the web site, which teaches how to clean dogs with skin conditions.

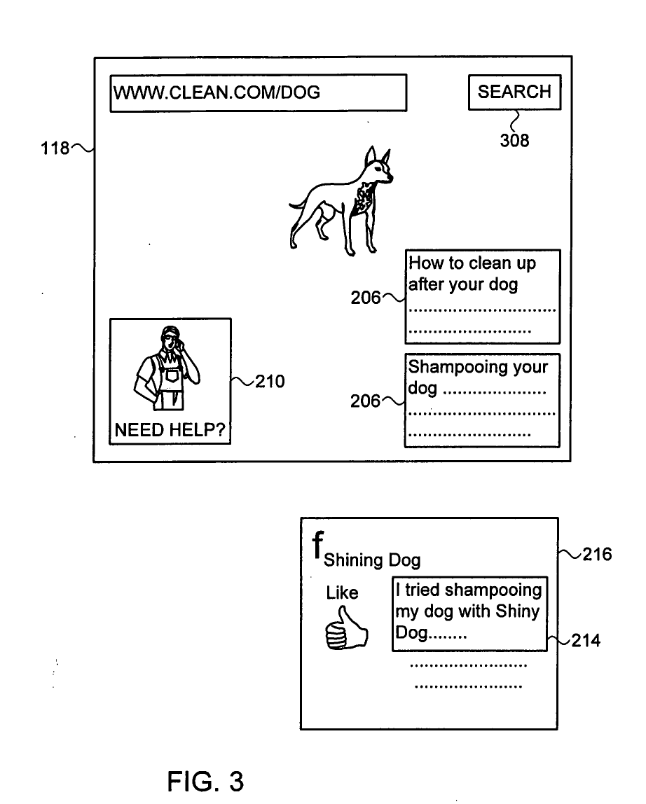

Reference is made to FIG. 3, a depiction of a ‘help’ and tracking function that may appear on one or more screens of a web site, in accordance with an embodiment of the invention. In operation, a user may visit or surf to web site 118, and may be presented with a search function 308 or an automated navigation function that may appear in one or more web pages or in other areas on the web site 118, and that may prompt the user with questions, queries or suggestions on how to locate content items 206 that are of interest to the user or topics 202 that may be of interest to the user. Such function may be part of a function that may be referred to as a robot 210 though other designations are possible. Robot 210 may include a series of software instructions to, among other things, interact with a user of web site 118. The user may input a search query or respond to robot 210 with a statement such as “I need to shampoo my shaggy dog who has demodectic skin”. Robot 210 may evaluate the query or request, and identify significant terms 203 in the query such as ‘dog’, ‘shampoo’, ‘shaggy’ and ‘demodectic’. Robot 210 may identify one or more topics 202 or sub-topics 204 that may include or be associated with such significant terms 203 in the words or responses of the user that are inputted to a search function on the web site 118 or to robot 210. A function of robot 210 may suggest, present or push to the user items of content that are associated with such topics 202 or sub topics 204 that were derived as being topics of interest of the user. Robot 210 may prompt a user with further questions, queries or chats to refine a search or to add more text or terms. Such additional text may allow robot 210 to refine its identification of topic 202 that may be of interest to the user.

In some embodiments, an automated chat function may be employed by for example computer 102 or processor 104 or other components, or a real-person chat may be interspersed with an automated string of chats. A live-person operator who takes over a chat string from an automated chat may be assisted in helping the user by detecting or identifying significant words 200 that were input by the user to robot 210 in the course of the automated chat string. One or more rules or policies may be programmed into robot 210 to properly time the transfer of a chat to a live person if a user for example asks for live help, becomes frustrated, is ready to buy or exhibits other designated behavior detected by robot 210.

In some embodiments, an indication of robot 210 may be perceptibly present to a user through chats, avatars or prompts of further questions presented to the user as follow-ups to the user's search. In some embodiments, robot 210 may function without user's awareness by presenting content items 206 that it deduces are of interest to the user or are part of a topic 200 that is of interest to the user. In some embodiments, robot 210 may track and store context and search terms presented by a user, and may alter web pages or content items 206 that that may be included in web pages 120 within the web site 212 that are to be presented to the user. In some embodiments, robot 210 may store in for example memory 106 or in some other memory unit, topics of interest of a particular user, and recall such topics in a same or later visit of the user to the web site.

Further search terms or answers of the user to the chat prompts may be subject to further analysis to extract significant words 200 that may be associated topics 202 which may be further associated with one or more content items 206. Content item 206 may be presented or pushed to the user, and the user may be asked again if such content item 206 is closer to his goal, desire or intent or topic of interest from the web site. Such presentation or push may display to the user a content item 206 that may include a portion of a web page within the web-site, such as a sentence of text, a snippet, a ‘thumbnail’ image or other parts of a web-page that may include one or more words that related to or that are association with the topic of interest of the user and the topic of the content item. The user may be asked if such presented text or content is close to his search goal, and if so, the relevant web-page may be delivered or presented to the user.

In some embodiments, a chat function may be programmed to ask the user relevant questions about what he is looking for, about his buying habits or other information that is pertinent to the user's visit at the web site. Such a chat function may be implemented through for example the Chatscript engine or other automated chat programs.

In some embodiments, content item 206 that appears on a first web site 118 may be linked or associated with topics 202 or sub-topics 204 or content items 214 on another web-site 216. For example, an owner of web site 212 that promotes cleaning products may also maintain a blog, a FaceBook™ page or other social web site 216 page for one or more of the products that is promoted on web-site 118. In such example, robot 210 may respond to a search request by a user for information about the effects of a dog shampoo on shaggy dogs with demodectic skin, with a push presentation of a string of comments, posts, pictures or discussions on a related social web site 216 page by users of the relevant product on such dogs.

Terms or words that are known to relate to identified or assembled topics 202 or fields of interest, but that do not appear in the content of the web site 118 may be added to a list of terms in a topic 202 and stored in a memory. For example, a pre-assembled list of terms or phrases that are known to be relevant to a field, such as for example, terms relating to cleaning of dogs or animals, may be associated with content item 206 on web site 212. Associations of such terms with the topics 202 to which they relate may be pre-defined or may be created or designated by an owner or operator of web site 212. Such associations may be stored to link the words 200 that are part of a topic 202 or sub-topic 204, with content item 206 or promotions on the web site 118 that are relevant to such topics 202 and sub-topics 204. Such linking may be performed automatically by associating topics 202 that include the designated word 200, with content items 206 that also include the designated word 200. A web site owner or manager may also create or customize links of words to topics 202 and to content items 206.

For example, a function of robot 210 may scan or parse web site 212 and its related social web site 216 page on a periodic or continuous basis and collect words or phrases that may be deemed significant, and associate the content items 206 in which such words were found, to a topic 202. Likewise, such parsing may associate topics 202 with sub-topics 204. Such associations may be performed automatically or may be established by an owner or manager of web site 118.

In some embodiments, a function may parse and evaluate content that is posted on a social web site 216 page, and may hide or eliminate negative or unwanted comments about a product, service or company, or may include as content items to be presented to a user those of the comments on the social web site that are deemed favorable to a product, service or other topic of the web site. Unwanted or negative comments may be identified with a capability such as those provided by the iMatch service, available from Softlib Software Ltd. of Tel Aviv Israel, though other products may be used having such capability. In some embodiments, a site may rely on a ‘LIKE’ rating provided by a user of a site, and expose only those comments that were given a like on the social web site 216. Selection of comments on a social web site 216 to be hidden or displayed may also be done manually, or by a natural language search function that looks for negative words or contexts in a phrase or sentence that is posted on the site 216.

In some embodiments an indication of a relative significance of words 200 or phrases that appear in a web site 118 may be gleaned from for example a series of words that include consecutive nouns or nouns and adverbs, such as for example ‘shaggy and long-haired dogs with peeling skin’. Other indicators of a relative significance of words 200 may be a bolding or font-based emphasis of the words 200 in a content item 206, a name of a web page or heading of paragraph. Other indicators may be used, and words 200 that are deemed to be significant may be added, either automatically or by a site owner, as relating to a particular topic 202. In some embodiments, robot 210 may implement an indexing function such as for example Lucene software (available from The Apache Software Foundation) to link topics 202 to content items 206. In some embodiments search engines such as those provide by the Google™ search site may be employed to find words 200 that are in a topic 202, and to find content items 206 within web site 118 that include such words 200 or that include other words in the same topic 202. Words that are generic or redundant to a search on a particular web site may be ignored or rated as less significant when finding a topic 202 of interest to a user. In the example discussed above, the word ‘clean’ may be deemed as not very significant since many queries on a site for cleaning products would use such word. A generic or redundant word might therefore be ignored or be deemed of low significance when interpreting an intent or topic of interest of a user of a web site who poses a question or search on the web site. If a word or a phrase in a search request is not recognized as being connected to a topic 202, robot 210 or some other function may ask the user to rephrase the search or provide other words or teams that are related to the search term that was not recognized. For example, if the term demodectic skin is not recognized by robot 210, the user may be prompted with questions like ‘do you mean a skin disease?’ or other ‘do you mean . . . ’ questions to account for misspellings or misuse of terms in a search request. In some embodiments, a record may be stored of similar queries to those that are not recognized by a system, and ‘do you mean’ responses may be selected based on statistics of similar, past unrecognized queries. Robot 210 may also tell the user that too many content items 206 have been found, and request that the user refine his search to narrow the number of results.

In some embodiments, robot 210 or some other function or process may perform a periodic or continuous scan of a web site 118, talk-backs or social web site 216 page to collect and categorize such terms, and to associate the terms with topics 202, sub-topics 204 and content items 206 and 214.

In some embodiments, a relevant topic 202 or subtopic 204 for a user within a subject web site, may be gleaned or detected from one or more words from a user's search request or other data that was input into a search engine (such as from a Google or Amazon search), by which a user may have arrived at or from which a user may have been directed to the subject site, such page may be referred to as a landing page.

In some embodiments, a history or past experience of a user on (e.g. when interfacing with or using) web site 118 may be recorded and stored in a memory such as memory 119. When the user re-visits web-site 118, the past context or history of the user's interests or topics of interests may be recalled, and a topic 202 or sub-topic 204 reflecting such recorded data may associated with a current interest of the user. For example, one or more pages viewed by the user may be saved in a memory, or a landing page onto which the user navigated to the site may be saved and referred to in a current or later visit of the user to the site. Past questions, searches or chat topics may be saved and referred to in a current or later visit of the user to the site or as a basis for delivering content items 206 to the user. For example key or significant words in past searches or visits of the user may be used as a basis for finding topics of interest of the user in a current search or visit.

In some embodiments, a web site owner or manager may provide to robot 210 a list of frequently asked questions (FAQs) and pre-prepared answers. For example, robot 210 may be pre-programmed to respond with pre-set answers or content items 206 to questions such as ‘what hours are you open?’ ‘what is the price of dog shampoo?’, ‘what is your address?’, and other FAQs. Significant words that would usually be found in such FAQs may be associated with particular content items 206 that may be presented to the user upon posing such questions. Other rules or pre-defined responses to FAQs may be added to functions of robot 210 by a web site owner or manager. When a query is posed by a user, robot 210 may determine if such query is associated with an instruction to present a pre-defined answer or pre-defined instruction that may be included in a content item 206. If no such pre-defined instruction is found or in other situations, an analysis of the query and its related topics may be undertaken.

In some embodiments, robot 210 may track and collect statistics that may correlate for example one or more web pages or series of web pages that were viewed by visitors who ultimately purchased from the site, who continued to interact with the site or conversely, a web page viewed by visitors who navigated away from the site without purchasing. Robot 210 may likewise record and assemble statistics on which search terms that were used or web pages that were viewed resulted in purchases of certain products. Robot 210 may use such statistics to steer or push content or web pages to users in reliance on past history and behavior of this or other users. For example, a user may provide input to robot 210 in the form for example of chat or responses to inquiries of robot 210. Robot 210 may in response to the user's chat, present to the user content items 206, and follow up with further queries to the user about the accuracy of the match of the content item 206 presented to the user's query. Records of the matches of content items 206 to chat responses may be kept and relied upon to predict appropriate responses to future user requests.

In some embodiments it may not necessary to collect, categorize and create topics 202 based on words 200 or phrases that appear in or that were collected from a web site. Content items 206 may be categorized into or associated with pre-defined or assembled topics 202 and subtopics 205, and links between one or more content items 206 may be established and designated. A user may view a first content item 206, and a processor or robot 210 may present the user with a second content item 206 that is associated with a topic 202 that is present in the first content item 206. In some embodiments, a content item 206 may be associated with two or more topics 202, and robot 210 may track and store topics 202 that are common to two or more content items 206 viewed by a user to find a common theme or topic of interest between the two or more content items 206 viewed by the user. In some embodiments, the greater the number of content items 206 viewed by a user (either in a current visit to the web site 118, or from past visits to the web site 118), may allow a more accurate detection of a topic an interest of the user, and the assumption that the user's topic of interest is present in or associated with at least some of the content items 206 viewed by the user. Likewise, if one or more content items 206 is associated with several topics 202, a series of content items 206 viewed by the user may allow topics 202 present in or associated with only some of such pages to be eliminated, so that topics 202 that are common to the viewed content items can be assumed to represent the user's actual interest.

In some embodiments, topics 202 of content items 206 viewed by a user may be stored and associated with the user so that in future visits of the user to the web site 118, content items 210 about the known and stored topics 202 of interest to the user may be presented to the user. In some embodiments search terms inputted by a user to robot 210 or to a search engine that led the user to the web site 118, may be evaluated for similarity or relatedness to a topic 202, and content items 206 may be presented to the user that relate to the topics of interest derived from such inputted data, words or search terms. In some embodiments, past interactions of a user with the web site 118, such as past purchases, orders, searches or queries by the user on the web site 118, may be saved so that content items matching the interests of the user may be presented in current or future visits of the user to the web site 118.

In some embodiments, a processor or robot may evaluate a web site 118, and detect a structure of certain content items 206 or arrangements of content items 206 in the site. Associations of one or more content items 206 with topics 202 may be based on such structure. For example, web site 118 may include a top or bottom bar of links for “Home, Products, Partners, Customers, Contact Us, About” or other similar structures providing links to content items 206 within web site 118. Robot 210 may evaluate content items 206 that are found in for example a Contact Us link, and may associate such content items 206 with topics 202 related to location queries such a ‘How do I get to your store“. Robot 210 may evaluate content items 206 in for example the Customers link, and may associate content items 206 connected under such Customers link with search requests or topics that relate to customers.

In some embodiments, an evaluation of a structure of web site 118 may be performed and an series of associations of content items 206 with topics 202 based on such structure may be developed on a periodic basis, and updated based on for example patterns of viewing of content items 206 by users.

In some embodiments, a ranking may be established to associate content items 206 with particular topics 202, and an indication of a relative frequency of viewing of a particular content item 206 by a user who is identified with a particular topic of interest. For example, a record of user views may indicate that many users who buy a particular product, first view one or more particular web pages. Such ranking may rate a particular content item 206 as very relevant to users who are interested in a particular topic 202. An indication of such high relevance may be stored, and the content item 206 may be presented to such user or other users who may also be interested in the topic 202.

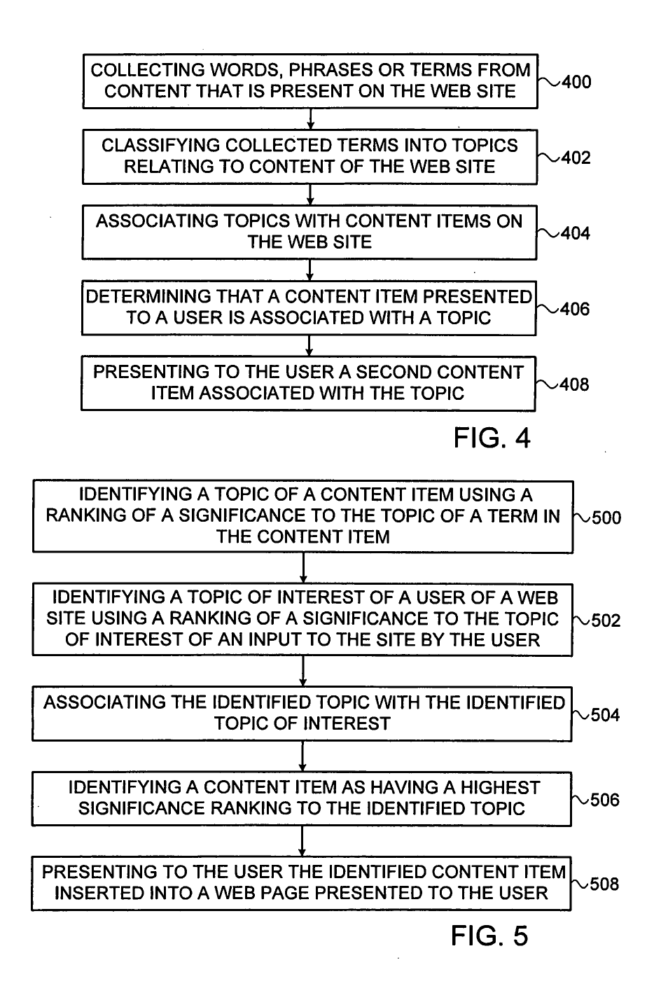

Reference is made to FIG. 4, a flow diagram of a method in accordance with an embodiment of the invention. A method of an embodiment may present data to a user or visitor on a web site by, as is shown in block 400, collecting words, phrases or terms from content that is present on the web site. In block 402, the collected terms may be classified into one or more topics, sub-topics and sub-sub-topics relating to content of the web site or of a field of the web site. In block 404 one or more of such topics or the terms in such topics may be associated with one or more content items appearing on the web site. In block 406, it may be determined that an item of content that is presented to a user of the web site is associated with a topic. In block 408, a second item of content that is associated with the topic may be presented to the user.

Some embodiments may include accepting a search query from a user of the web site and associating words in the search query with the first topic. Some embodiments may include accepting a search query from a user of a second web site such as a social web site page, and associating the search query with the first topic. Some embodiments may include finding an item of content that is associated with a first topic in one or more web pages presented to the user. Some embodiments may include classifying words, terms or phrase into predefined topics. Some embodiments may include determining that a search term presented by a user is associated with a particular topic. Some embodiments may present a prompt to a user, where the prompt is associated with a particular topic. Some embodiments may include presenting to the user a pre-prepared content or response in response to a query. Some embodiments may include presenting to the user an item of content on a second web site, where the content is associated with the topic. Some embodiments may include storing an association of the user with the topic, and presenting to the user another item of content on the web site or social site when such association is recalled. Some embodiments may include altering a combination of content items presented in a web page to include a particular item of content, such as a banner or promotion on the presented page when the association of the user and the topic is recalled. Some embodiments may include storing an indication of an item of content that is presented to the user, and associating the indication with an action of the user on said web site, such as a past purchase or acceptance of a promotion.

In some embodiments, words, terms or phrases in one or more content items in a web site may be identified as possible topics of content items on the web site, and such words or phrases may be assembled into a list of topics of the web site. In some embodiments, lists of topics may be prepared by an owner or operator of a web site on a periodic basis, or such lists may be generated on an on-going or real time basis when content items are added to a web site. In some embodiments, collections or lists of possible topics of the web site or for topics for some or all of the content items on a web site may be generated automatically, by for example performing a review or crawl (e.g., by an automatic process) of some or all of the content of a web site, and identifying words, phrases or terms that may be deemed topics.

In some embodiments, the appearance in a content item of a word, term or phase that represents or is associated with a topic may be an indication that such content item is to be identified with the topic. In some embodiments, a method of the invention may identify one or more topics that are relevant to a content item on the web site, and may assign a significance ranking of such topic to the content item.

For example and related to the discussion of FIG. 3 above, a list of topics that may be present in a web site may include clean, pet, dog, cat, fur, skin, and shampoo. A series of web pages on the site may include offers and descriptions of pet combs, brushes, mats, and shampoos. One of such pages may include offers and descriptions of dog shampoos including an offer for a shampoo for dogs with sensitive skin. Combinations of such words such as ‘sensitive skin’, ‘pet shampoo’ and ‘cat fur’ may also be identified as sub topics on the web site.

Robot 210 may assign a relevance ranking for one or more of the words, phrases or terms that may be found in a particular content item to determining a topic of the content item or a relevance of the content item to a topic. Continuing the example in the discussion of FIG. 3 above, the term cleaning product as may appear in a content item may receive a low significance ranking for determining a topic of the content item since this term appears frequently on the web site, and such frequent use may be deemed to reduce its significance to any single topic. With respect to a topic of pets, the terms ‘dog’, ‘cat’, and the phrase ‘dog and cat’ may be ranked with a significance of for example 70 (on a scale of for example 0-100) in determining a topic of a content item that contains such term or phrase. The phrase ‘dog and cat fur’ may be ranked with a high significance for determining a topic of a content item wherein it appears since such term includes a list of nouns (after removal of the ‘and’) that may indicate a particularity of one of the nouns relative to the topic of pets and the sub topic of dogs. The phrase ‘shampoo for dogs’ may be ranked even higher with respect to the relevance of such phrase to a topic of a content item since it includes a pair of nouns separated by a preposition, indicating a specificity of the first noun ‘shampoo’ relative to the second noun ‘dog’. Similarly, the phrase ‘shampoo for dogs’ may be indicative of a significance of a phrase to a topic of a content item because it is a phrase with two or more nouns indicating a specificity of the object of interest. Applying this concept, the phase ‘sensitive skin shampoo’ may have a high significance rank to a topic of a web site that is higher than the word ‘shampoo’.

A term or phrase may be assigned a first significance ranking with respect to a first topic and a second significance ranking with respect to a second topic, such as a sub topic of the first topic. For example, the phrase “pets with sensitive skin” in a content item may be assigned a significance ranking of 70 to the topic of pets, and a significance ranking of 99 in the sub topic of pet skin. A web page that includes several sentences, images or groups of data may be ranked as to its significance for each, some or all of the topics that have been assembled for a web site.

In some embodiments, a portion of a content item, such as a sentence, paragraph, image or other data in a web page that includes a term, phrase or word that is relevant to a topic or subtopic may receive a separate ranking, so that a single web page or article may include numerous different rankings relative to different topics and sub-topics, each different ranking applying to a portion of such web page or content item. For example, a particular sentence or image may be formatted into a ‘thumbnail’ or ‘banner’ and inserted into or on top of a web page that is displayed or presented to a user. The thumbnail or banner may be hyperlinked for example to the larger web page where it was found, allowing a user to click on the thumbnail to navigate to the relevant web page. In this way a portion of a larger content item may itself be deemed a content item, and such portion may be selected as relevant to a topic, and presented to a user.

In some embodiments, such a ranking of content items to particular topics may be performed or supplemented by an owner or operator of a web site. In some embodiments, relationships among topics and sub-topics may be established either automatically or by an owner or manager of a web site, so that a significance ranking of a content item to a first topic is transferred and applied to a second topic, so that the content item which is rated as a significant to a first topic is also relevant to a second topic. Associations between topics, may be supplemented by reference to for example a thesaurus, an encyclopedia web site such as ‘Wikipedia™’ or other electronic data bases.

A ranking process of terms and phrases to topics may also be undertaken on inputs by a user or visitor to a web site to determine a topic of interest of the user. For example, one or more of the web pages requested by, visited by or viewed by a user may be ranked with respect to its significance to a topic. A ranking of a topic of interest of a user may also be captured from a ‘landing page’ such as the web page through which the user entered the web site from for example a third party search engine. A topic that appears in more than one of the viewed web pages may be deemed or ranked to have a high significance to the user's topic of interest. A word, phrase or term that is inputted by the user in a search on the web site or in a chat to robot 210 may also be ranked as to its significance to the user's topic of interest.

Continuing the example above, a user may navigate through one or more pages on a web site that include pet cleaning products. The user's topic of interest may thereby be ranked high for pet cleaning. A user may also input a search term or chat phrase such as “I am looking for a shampoo for my dog with sensitive skin to get rid of a skunk smell.” Embodiments of a method of the invention may assign for example, the following significance ranking to such input, as a measure of the topic of interest of the user:

shampoo (50)

shampoo for my dog (70)

shampoo for my dog with sensitive skin (95)

skunk smell (95)

dog shampoo sensitive skin skunk (99)

Scales or rankings other than 1-100 may be used, and scales or rakings other than numeric may be used. A selection may be made of a highest ranking topic of interest of the user for which there is also a similar or related topic that was identified on the web site, such that a topic on the web site is associated with or identified as relevant to a topic of interest of the user. A further selection or identification may be made of a content item on the web site having a significance ranking that is high or highest for such topic identified as relevant to the topic of interest. A snippet, thumbnail or banner of the relevant content item may be presented to the user.

In the example above, a highest significance ranking of an input of a user for determining a topic of interest of the user may have been derived for “dog shampoo sensitive skin skunk”, but since there was no topic on the web site that matched such phrase, an embodiment of the invention may select a highest ranking topic of interest that was associated with an identified topic of content items on the web site.

In some embodiments, factors in determining a ranking may include an appearance in a title of a content item or web page (e.g., URL) of a term or topic that is included in an input of a user, such as a query or search term. A placement of two or more terms in a query of a user, such as next to each other or at a measurable contextual distance such as separated by an adjective or adverb, and a similar placement of such two or more terms in a content item may also be used in establishing a ranking relevance. Other factors may include a placement of a term in a first few words, first sentence, first paragraph, or first half of a content item, or a font such as a bold or type size of the term in a content item. In some embodiments, a relevance of a search or inputted term may be increased by its non-appearance in a dictionary, which may indicate that the term is for example a trade name or brand, so that nouns, and particularly proper nouns may be ranked higher than adjectives. Complex or multi-word phrases, that may appear with some frequency, such as for example “Business Availability Center” or “Sport Utility Vehicle” that appear in an input from a user or in a content item may be ranked highly as they may indicate that the complete term, rather than just its component words, represents the item or topic sought by the user. Similarly, terms or phrases with contiguous numbers, such as “56 Chevy”, may indicate that a search term or content item refers to a particular version, model year or other product designation. In some embodiments a duration of viewing, such as a number of seconds or minutes, by a user of a particular content item or portion of a content item, may increase a ranking of a topic of the content item or portion of the content item, and its relevance to the user.

In some embodiments any suitable scale may be selected to for measuring significance of a word, term or phrase in a content item to a topic. For example, a numeric scale of for example 1-100 may be applied for measuring such significance, or an indication of significant, very significant or very, very significant may be used. For example, a content item that describes how to bathe a dog with sensitive skin may be relevant to a topic of dogs, very relevant to a topic of clean dogs, and may be very, very relevant, or have a highest relevance to a topic of dog shampoo.

Reference is made to FIG. 5, a flow diagram of a method in accordance with an embodiment of the invention. In some embodiments, a method in accordance with an embodiment of the invention may include as in block 500, identifying, for one or more content items on a web site, a topic of a particular content item from a group of topics, where such identifying uses a ranking of a significance to the topic of a term in the content item. In block 502, a method may include identifying a topic of interest of a user of the web site from a group of topics of interest, where such identifying uses a ranking of a significance to the topic of interest of an input to the web site of the user. In block 504, a method may include associating the identified topic with the identified topic of interest. In block 506, a method may include identifying a first of the content items as having a highest significance ranking to the identified topic. In block 508, a method may include presenting to the user the identified content item as it is inserted into a web page of the web site presented to the user.

In some embodiments, identifying a topic of interest of the user includes deriving the user's topic of interest from an association of a topic of interest with a word, term of phrase inputted to the web site by the user. In some embodiments, identifying the user's topic of interest includes identifying a topic that is common to r that appears in more than one content item on the web site that is viewed by the user. In some embodiments, identifying the user's topic of interest includes deriving the user's topic of interest from an association of the topic of interest with a word that is inputted by the user in a search function of a second web site, such as a search engine from which the user may have arrived at the particular web site. In some embodiments, identifying the user's topic of interest includes recalling or retrieving from a computer memory a stored topic of interest that is associated with the user, where the stored topic of interest was identified and associated with the user in a prior visit of the user to the web site.

In some embodiments, associating content items on a web site includes identifying a location of a content item in a structure of the web site, and selecting a second content item based on the location of the second item in the structure of the web site.

In some embodiments, a method may include inserting the second content item into or as part of a web page to be presented to the user.

In some embodiments, a method may include collecting terms from data stored on web pages of the web site; associating certain of the collected terms with a particular topic; and determining that a second content item on the web site is associated with a particular topic. The second content item may be presented to the user.

In some embodiments a method may include presenting the second content item to the user in an order of a ranking of a relevance of the second content item to the topic that was determined to be a topic of interest to the user.

Some embodiments of the invention may include prompting the user to provide input to the web site about the user's topic of interest.

It will be appreciated by persons skilled in the art that embodiments of the invention are not limited by what has been particularly shown and described hereinabove. Rather the scope of at least one embodiment of the invention is defined by the claims below.

We claim:

1. A method of selecting a content item to present to a user of a web site, comprising:
for each of a plurality of content items on said web site, identifying a topic of said content item from a plurality of topics, using a ranking of a significance to said topic of a term in said content item;
identifying a topic of interest of a user of said web site from a plurality of topics of interest, using a ranking of a significance to said topic of interest of an input to said web site of said user;
associating said identified topic with said identified topic of interest;
identifying a first of said plurality of content items as having a highest significance ranking to said identified topic; and
presenting to said user said first of said plurality of content item inserted into a web page of said web site presented to said user.

2. The method as in claim 1, wherein identifying said topic of interest of said user comprises ranking of a significance to said topic of interest of a word inputted by said user into a search engine of a second web site.

3. The method as in claim 1, wherein identifying said topic of interest of said user comprises ranking of a significance to said topic of interest of a word inputted into said web site by said user.

4. The method as in claim 1, wherein identifying said topic of interest of said user comprises ranking of a significance to said topic of interest of a request for a web page of said web site inputted into said web site by said user.

5. The method as in claim 1, wherein identifying said topic of interest of said user comprises ranking of a significance to said topic of interest of a web page first presented to said user upon an entry by said user into said web site.

6. The method as in claim 1, wherein said identifying a topic of a first of a plurality of content items on said web site by a ranking of a significance to said topic of a term in said first content item, comprises ranking said significance from a factor selected from the group consisting of a format of said term in said content item, a position of said term in a title of said content item, an appearance of said term in a title of said content item, a number of words included in said term, an appearance of a number in said term, and an appearance of a proper noun in said term.

7. The method as in claim 1, wherein said identifying a topic of a first of a plurality of content items on said web site by a ranking of a significance to said topic of a term in said first content item, comprises counting a frequency of a use of said term in said first content item.

8. The method as in claim 1, wherein said identifying a topic of a first of a plurality of content items on said web site by a ranking of a significance to said topic of a term in said first content item, comprises counting a frequency of a use of said term in said first content item relative to a use of said term in other content items of said plurality of content items.

9. The method as in claim 1, wherein said presenting comprises presenting a portion of said content item, said portion including less than all of said content item, and said portion including said term.

10. The method as in claim 1, comprising:
identifying a first of a plurality of content items on a second, web site by a ranking of a significance of said first of said plurality of content items on said second web site to said topic; and
presenting to said user said first of said plurality of content items on said second web site inserted into said web page presented to said user.

11. The method as in claim 1, comprising:
recording an association of said topic of interest with said user, and recalling said association upon a visit of said user to said web site.

12. A system for selecting content items to present to a user of a web site, the system comprising:
a memory to store a plurality of topics and a plurality of content items of said web site, and
a processor, said processor to:
identify a topic of said plurality of topics of a first of said plurality of content items on said web site by a ranking a significance to said topic of a term in said first content item;
identify a topic of interest of a user of said web site by a ranking of a significance to said topic of interest of an input of said user to said web site;
associate said topic with said topic of interest;
identify said first of said content items as having said term with a highest significance ranking to said topic; and
present to said user said content item inserted into a web page of said web site presented to said user.

13. The system as in claim 12, wherein said processor is to identify said topic of interest of said user by a ranking of a significance to said topic of interest a word inputted into into a search engine of a second web site.

14. The system as in claim 12, wherein said processor is to identify said topic of interest of said user by a ranking of a significance to said topic of interest of a request for a web page of said web site inputted into said web site by said user.

15. The system as in claim 12, wherein said processor is to identify said topic of interest of said user by a ranking of significance to said topic of interest of a web page first presented to said user upon an entry by said user into said web site.

16. The system as in claim 12, wherein said processor is to
record in said memory an association of said topic of interest with said user, and
recall from said memory said association upon a visit of said user to said web site.

17. A method for presenting data on a web site, the method comprising:
collecting a plurality of terms from content on said web site;
associating a first of said plurality of terms with a topic;
associating said topic with a plurality of content items on said web site;
determining that a first content item from said plurality of content items presented to a user of the web site is associated with said topic; and
presenting to said user a second content item from said plurality of content item.

18. The method as in claim 17, comprising accepting a term from a user of said web site, and associating said term with said topic.

19. The method as in claim 17, comprising presenting a prompt to said user, said prompt associated with said topic.

20. The method as in claim 17, comprising storing an association of said topic with an identity of said user.
